(19) United States
(12) Patent Application Publication
(10) Pub. No.: US 2024/0286959 A1
(43) Pub. Date: Aug. 29, 2024

(54) HIGH-SATURATION AND LOW-LOSS BI-COMPONENT MICROWAVE FERRITE MATERIAL, AND PREPARATION METHOD THEREFOR AND USE THEREOF

(71) Applicant: HENGDIAN GROUP DMEGC MAGNETICS CO., LTD, Dongyang City Jinhua, Zhejiang (CN)

(72) Inventors: Yuanzhen WANG, Dongyang City Jinhua, Zhejiang (CN); Likang ZHANG, Dongyang City Jinhua, Zhejiang (CN); Feiyu LV, Dongyang City Jinhua, Zhejiang (CN); Yangzhong DU, Dongyang City Jinhua, Zhejiang (CN)

(21) Appl. No.: 18/571,679

(22) PCT Filed: Nov. 10, 2021
(86) PCT No.: PCT/CN2021/129668

§ 371 Date: Dec. 18, 2023

(30) Foreign Application Priority Data
Jul. 12, 2021 (CN) 202110784246.2

(51) Int. Cl. C04B 35/26; C04B 35/626; C04B 35/634; C04B 35/64

(52) U.S. Cl. CPC C04B 35/2641; C04B 35/6261; C04B 35/62655; C04B 35/63416; C04B 35/64; C04B 2235/3274; C04B 2235/5436; C04B 2235/5445; C04B 2235/5463; C04B 2235/6567; C04B 2235/77

(57) ABSTRACT

The present application provides a high-saturation and low-loss bi-component microwave ferrite material, and a preparation method therefor and the use thereof. The high-saturation and low-loss bi-component microwave ferrite material comprises a first microwave ferrite material and a second microwave ferrite material. The preparation method comprises the following steps: (1) mixing a first microwave ferrite material with a second microwave ferrite material according to the formula amounts, and then performing wet ball milling to obtain a ball-milled material; (2) drying the ball-milled material obtained in step (1), and sieving and then granulating same; and (3) sequentially forming and sintering the granulated particles obtained from step (2) to obtain a high-saturation and low-loss two-component microwave ferrite material.

### TECHNICAL FIELD

The present application relates to the fields of microwave communications and magnetic materials, and relates to a high-saturation low-loss bi-component microwave ferrite material and a preparation method therefor and use thereof.

### BACKGROUND

Microwave ferrite devices occupy an important place in microwave technology and have been widely applied to aerospace, satellite communications, electronic countermeasures, mobile communications and medical fields. Microwave ferrite materials, as the core of the devices, are widely used in the various fields. 5G communication is an important part of the future information infrastructure and relies on microwave as a means of transmission; circulators and isolators are indispensable devices for the 5G communication, and it is particularly important for circulators and isolators to realize miniaturization and lightweight. The dielectric constant of existing microwave ferrite is between 12 and 16, and for the design of low-frequency circulators and isolators, the device size is large, which cannot meet the needs of miniaturization and integration. As one of the main parameters of device design, the dielectric constant ε′ is closely related to the device size. When the electromagnetic wave is propagating in a medium, the wavelength is inversely proportional to the square root of the dielectric constant, and thus increasing the dielectric constant of the material is an important means of device miniaturization. The ferrite radius R of a stripline circulator has the following approximate formula:

$$R = \frac{1.84}{k} = \frac{1.84}{( ω / c ) \sqrt{{ε}_{f} {μ}_{eff}}} ;$$

wherein k is the effective wavenumber, ω is the operating angular frequency, c is the speed of light, ε_{f} is the real part of the dielectric constant ε′ of ferrite, and μ_{eff} is the effective permeability. The μ_{eff} is calculated by the following formula:

$${μ}_{eff} = 1 - {( k / μ )}^{2} = 1 - {P}^{2} ;$$

wherein (k/μ) is the splitting factor of ferrite and P is the normalized saturation magnetization of ferrite, and P=ωₘ/ω,

wherein ωₘ=γMs, Ms is the saturation magnetization and γ is the gyromagnetic ratio. It can be seen that the radius of the ferrite disk is inversely proportional to the square root of the dielectric constant ε′. It also has been proved by the practice that improving the dielectric constant of the material can indeed effectively reduce the size of the device.

Previous researches on microwave ferrite materials have mostly focused on the microwave loss of the material, while barely pay attention to the saturation magnetic moment. With the rapid development of microwave technology, the system requirements for component miniaturization are increasingly urgent; moreover, the volume of ferrite components is much higher than other components, so the miniaturization and lightweight task of ferrite components is particularly important.

There are two types of operating magnetic field zones of circulators, i.e. high-field zone and low-field zone. In recent years, the circulators used in communications are developing rapidly, and the demand for high-field circulators is far more than the demand for low-field circulators. The high-field zone operation means that the operating internal field of ferrite is higher than the resonance field of the operating frequency; the resonance field Hr=ω/γ is fixed, the operating internal field Hi>Hr, and the normalized internal field is σ=Hi/Hr. When σ>1, it can be called as the high-field operation, and generally σ is 1.1-2.4. High-field circulators are generally suitable for low-frequency bands. Any frequency lower than 4 GHz can be used; high-field circulator design has the following advantages:
(1) under the high-field operation conditions, the material is fully saturated and avoids zero-field loss, which is favorable to low-loss devices, and the current low-linewidth material ΔH=100e is very suitable for high-field operation, and its insertion loss is very small; and
(2) the normalized magnetic moments p=γ4πMs/ω of the materials selected for the circulators for high-field operation are all greater than 1, or even reach tens, which greatly reduce the size of samples (or the size of devices); based on the design experience, the diameter of ferrite samples is: Df≈λ₀/40−λ₀/10 (λ₀ is the wavelength of the corresponding frequency).

The circulator for high-field operation plays a dual role; in the fundamental band (f₁-f₂), it has circulator characteristics; in the second harmonic band (2f₁-2f₂), it has forward and reverse isolation characteristics, i.e., it has low-pass filter (LPF) characteristics, which serves as a circulator and provides harmonic suppression. The mechanism of harmonic suppression is described as follows: for the designed circulator at 300-500 MHz, in a case where the frequency f₁=300 MHz, its normalized magnetic field σ=1.67, and for f₂=500 MHz, its σ=1.18. For the frequency 2f₁=600 MHz, its normalized magnetic field σ=1.67/2=0.835, and for 2f₂=1000 MHz, its σ=1.18/2=0.59; therefore, when the circulator is operated in the (2f₁-2f₂) second harmonic frequency domain, the low field, where σ∈(0.59, 0.835), its tensor permeability is less than 0, thus the circulator propagates vanishing, thus the propagation coefficients |S12| and |S21| are both very small; in general |S12|, |S21|∈(0.1, 0.02) order of magnitude, so attenuation is very large, and a part of the energy is reflected |S1| (dB)|≤2 dB, and part of the energy is absorbed by the ferromagnetic resonance. |S11|∈(0.76, 0.96) and varies in the range; the value of |dS| for the second harmonic generation is very small and dS∈(0.02, 0.1) and varies in the range. Using the formula:

$$dS = {S}_{12} - {S}_{21} = \frac{j ω}{2} {\int }_{all} ( {h}_{1} \cdot μ {h}_{2} - {h}_{2} \cdot μ {h}_{1} ) dV ;$$

to calculate the |dS| values of three frequency points (2f₁, f₁+f₂, 2f₂), and the results are |dS|=(0.091, 0.058, 0.024), so its non-reciprocal |dS| value is smaller than the value at fundamental frequency by the above order of magnitude, and in the general circular state, |dS|→1, and thus the |dS| parameter of the second harmonic is 10-50 times smaller than that of the fundamental; the non-reciprocity of the second harmonic can be ignored.

From the above, it can be seen that the key for miniaturization and integration of the circulator is to use a microwave ferrite material with a small line width, low loss, high Curie temperature, and suitable 4πMs, and the study of such microwave ferrite material is of great significance.

CN102584200A discloses an ultra-low loss and small linewidth microwave ferrite material and its preparation, and the chemical formula of the material is Y_{3-2x-y}Ca_{2x+y}Fe_{5-x-y-z}VₓZr_{y}Al_{z}O₁₂. The preparation method comprises: calculating and weighing raw materials according to stoichiometry, vibratory ball milling, pre-sintering, coarse pulverization by vibratory milling, fine pulverization by sand milling, spray granulation, compression molding and sintering. The technical solution can be used in the fields of microwave communications and magnetic materials, and the method provides an ultra-low loss and small linewidth microwave ferrite material; during the preparation, the pre-sintering and sintering are required to be performed at high temperature, which is not conducive to production and environmental protection.

U.S. Pat. No. 8,696,925B2 discloses a high dielectric constant garnet ferrite with the chemical formulas of Y_{2.15-2x}Bi_{0.5}Ca_{0.35+2x}Zr_{0.35}VₓFe_{4.65-x}O₁₂ and Bi_{0.9}Ca_{0.9+2x}Y_{1.2-2x}Zr_{0.7}Nb_{0.1}VₓFe_{4.2-x}O₁₂, wherein the ranges of x are 0-0.8 and 0-0.6, respectively, and the correspond dielectric constant is 20-30, and 4πMs is 1000-2000 Gs. However, the dielectric constant in this patent still cannot satisfy the practical needs, the preparation method is cumbersome, and the toxic V₂O₅ is not environmentally friendly.

### SUMMARY

The present application is to provide a high-saturation low-loss bi-component microwave ferrite material, a preparation method therefor and use thereof. The bi-component microwave ferrite material provided by the present application is characterized by the small line width, high Curie temperature, high saturation magnetic moment, and low loss, which greatly improves the stability and reliability of the microwave ferrite material; and the method of the present application is stable and repeatable, which is suitable for mass production and greatly reduces the production cost.

The term “high-saturation low-loss” as used in the present application refers to a saturation magnetization of 1950 Gs-1960 Gs and a dielectric loss of 1.48×10⁻⁴-2×10⁻⁴.

To achieve the object, the present application adopts the technical solutions below.

In a first aspect, the present application provides a high-saturation low-loss bi-component microwave ferrite material, and raw materials for the high-saturation low-loss bi-component microwave ferrite material comprises a first microwave ferrite material and a second microwave ferrite material; and

wherein the first microwave ferrite material is: Y₃₋ₐCaₐFe_{5-a-b-c}ZrₐIn_{b}Mn_{c}O₁₂, wherein 0≤a≤0.7, which may be, for example, 0, 0.1, 0.2, 0.3, 0.4, 0.5, 0.6 or 0.7, but is not limited to the listed values, and other unlisted values within the numerical range are also applicable;

0≤b≤0.7, which may be, for example, 0, 0.1, 0.2, 0.3, 0.4, 0.5, 0.6 or 0.7, but is not limited to the listed values, and other unlisted values within the numerical range are also applicable; and

0≤c≤0.7, which may be, for example, 0, 0.1, 0.2, 0.3, 0.4, 0.5, 0.6 or 0.7, but is not limited to the listed values, and other unlisted values within the numerical range are also applicable; and

wherein the second microwave ferrite material is: Gd_{3-A}Ca_{A}Fe_{5-A-B-C}Ge_{A}In_{B}Ti_{C}O₁₂, wherein 0≤A≤0.7, which may be, for example, 0, 0.1, 0.2, 0.3, 0.4, 0.5, 0.6 or 0.7, but is not limited to the listed values, and other unlisted values within the numerical range are also applicable;

0≤B≤0.7, which may be, for example, 0, 0.1, 0.2, 0.3, 0.4, 0.5, 0.6 or 0.7, but is not limited to the listed values, and other unlisted values within the numerical range are also applicable; and

0≤C≤0.7, which may be, for example, 0, 0.1, 0.2, 0.3, 0.4, 0.5, 0.6 or 0.7, but is not limited to the listed values, and other unlisted values within the numerical range are also applicable.

Optionally, a mass ratio of the first microwave ferrite material to the second microwave ferrite material is (1-3):(1-3), which may be, for example, 1:1, 1:2, 1:3, 2:3, 3:2 or 3:1, but is not limited to the listed values, and other unlisted values within the numerical range are also applicable.

Pure yttrium iron garnet ferrite has low load carrying capability and large ferromagnetic resonance linewidth and dielectric loss, and its sintering temperature is high and its performance is relatively ordinary. In the present application, by using Zr⁴⁺ to partially replace Fe³⁺ in the octahedral geometry, the anisotropy constant of the magnetic crystals can be reduced, and the ferromagnetic resonance linewidth can be reduced, but Zr⁴⁺ cannot be too much, or the ferromagnetic resonance linewidth will be increase rapidly; Ca²⁺ is a low melting point material, which can be doped to reduce the sintering temperature; using a small amount of Mn²⁺ to substitute part of Fe³⁺ can reduce the material's ferromagnetic resonance linewidth and dielectric loss; using Gd³⁺ ions to substitute Y³⁺ can improve the temperature coefficient of Ms, in turn maintaining a high Curie temperature. By adjusting the composition of the microwave ferrite material and taking advantage of the cooperative effect of the electromagnetic characteristics of each element in the present application, the microwave ferrite material thus obtains a higher saturation magnetization 4πMs, narrower ferromagnetic resonance linewidth ΔH, lower dielectric loss tgδe and higher Curie temperature Tc.

In a second aspect, the present application provides a preparation method for the high-saturation low-loss bi-component microwave ferrite material as described in the first aspect, and the preparation method comprises the following steps:
(1) mixing the first microwave ferrite material and the second microwave ferrite material according to a formulation proportion, and then performing wet ball milling to obtain a ball-milled material;
(2) drying the ball-milled material obtained in step (1), sieving and performing granulation; and
(3) molding and sintering particles after granulation in step (2) sequentially to obtain the bi-component microwave ferrite material.

Optionally, the wet ball milling in step (1) is performed with mixing the raw materials, mill balls and a dispersion medium according to a mass ratio of 1:(4-7.5):(0.6-2.5), which may be, for example, 1:4:0.6, 1:5:0.8, 1:6:1.2, 1:7:1.5, 1:7.5:2, 1:6.5:1.5, 1:4.5:2.5 or 1:5.5:2.5, but is not limited to the listed values, and other unlisted values within the numerical range are also applicable.

Optionally, the wet ball milling in step (1) is performed at a rotational speed of 20-80 r/min, which may be, for example, 20 r/min, 30 r/min, 40 r/min, 50 r/min, 60 r/min, 70 r/min or 80 r/min, but is not limited to the listed values, and other unlisted values within the numerical range are also applicable.

Optionally, the wet ball milling in step (1) is performed for 10-40 h, which may be, for example, 10 h, 15 h, 20 h, 25 h, 30 h, 35 h or 40 h, but is not limited to the listed values, and other unlisted values within the numerical range are also applicable.

Optionally, the mill balls comprise zirconium balls and/or steel balls.

Optionally, the mill balls comprise large-diameter mill balls and small-diameter mill balls.

The large-diameter mill balls have a diameter of 5-10 mm, which may be, for example, 5 mm, 6 mm, 7 mm, 8 mm, 9 mm or 10 mm, but is not limited to the listed values, and other unlisted values within the numerical range are also applicable.

The small-diameter mill balls have a diameter of 1-4 mm, which may be, for example, 1 mm, 2 mm, 3 mm or 4 mm, but is not limited to the listed values, and other unlisted values within the numerical range are also applicable.

Optionally, a mass ratio of the large-diameter mill balls to the small-diameter mill balls is (0.8-3):1, which may be, for example, 0.8:1, 1:1, 1.2:1, 1.4:1, 1.6:1, 1.8:1, 2:1, 2.2:1, 2.4:1, 2.6:1, 2.8:1 or 3:1, but is not limited to the listed values, and other unlisted values within the numerical range are also applicable.

Optionally, the dispersion medium comprises any one or a combination of at least two of deionized water, alcohol, acetone, n-acetone or ammonia, and a typical but not limiting combination comprises a combination of deionized water and alcohol, a combination of deionized water and acetone, a combination of deionized water and ammonia, a combination of deionized water, alcohol and ammonia, or a combination of deionized water, alcohol and acetone.

Optionally, a particle size range of the ball-milled material in step (1) is: D50=0.05-2 μm and D90=0.05-4 μm, which may be, for example, D50=0.005 μm, 0.01 μm, 0.05 μm, 0.1 μm, 0.5 μm, 1 μm, 1.5 μm or 2 μm, and D90=0.05 μm, 0.1 μm, 0.5 μm, 1 μm, 1.5 μm, 2 μm, 3 μm or 4 μm, but is not limited to the listed values, and other unlisted values within the numerical range are also applicable.

The length of period the wet ball milling takes in step (1) of the present application will affect the temperature required for sintering, and ultimately determine the sintering density, linewidth, dielectric loss or other properties of the material; different ball milling medium will affect the effect of ball milling, and the selection of mill balls will affect the stability and control difficulty of the process. Through the above ball milling conditions, a better ball milling effect can be obtained, the fineness can be reduced, the activity of the material can be improved and the sintering temperature can be reduced.

Optionally, the drying in step (2) is performed at 100-150° C., which may be, for example, 100° C., 110° C., 120° C., 130° C., 140° C. or 150° C., but is not limited to the listed values, and other unlisted values within the numerical range are also applicable.

Optionally, the drying in step (2) is stopped when a moisture content is reduced to 0.01-10%, which may be, for example, 0.01%, 0.1%, 1%, 3%, 5%, 7%, 9% or 10%, but is not limited to the listed values, and other unlisted values within the numerical range are also applicable.

Optionally, the sieving in step (2) is performed with a sieve of 30-100 mesh, which may be, for example, 30 mesh, 40 mesh, 50 mesh, 60 mesh, 70 mesh, 80 mesh, 90 mesh or 100 mesh, but is not limited to the listed values, and other unlisted values within the numerical range are also applicable.

Optionally, the granulation in step (2) comprises uniformly mixing a sieved ball-milled material and a binder and sieving under pressure to obtain granulated particles.

Optionally, the binder comprises an aqueous solution of polyvinyl alcohol.

Optionally, the polyvinyl alcohol solution has a concentration of 5-20 wt %, which may be, for example, 5 wt %, 10 wt %, 15 wt % or 20 wt %, but is not limited to the listed values, and other unlisted values within the numerical range are also applicable.

Optionally, the polyvinyl alcohol solution is 5-10% by mass of the powder, which may be, for example, 5%, 6%, 7%, 8%, 9% or 10%, but is not limited to the listed values, and other unlisted values within the numerical range are also applicable.

Optionally, the sieving is performed at a pressure of 300-1200 kg/m², which may be, for example, 300 kg/cm², 500 kg/cm², 700 kg/cm², 900 kg/cm², 1100 kg/cm² or 1200 kg/cm², but is not limited to the listed values, and other unlisted values within the numerical range are also applicable.

Optionally, the molding in step (3) comprises introducing the granulated particles in step (2) into a mold and compressing into a blank having a prescribed shape.

Optionally, the blank has a molding density of 3.0-4.0 g/cm³, which may be, for example, 3.0 g/cm³, 3.2 g/cm³, 3.4 g/cm³, 3.6 g/cm³, 3.8 g/cm³ or 4.0 g/cm³, but is not limited to the listed values, and other unlisted values within the numerical range are also applicable.

Optionally, the sintering in step (3) comprises heating to 1200-1500° C., which may be, for example, 1200° C., 1300° C., 1400° C. or 1500° C., but is not limited to the listed values, and other unlisted values within the numerical range are also applicable.

Too low or too high a sintering temperature in the present application will result in lower sintering density, increased linewidth, and increased dielectric loss.

Optionally, the sintering has a holding period of 5-30 h, for example, it may be 5 h, 10 h, 15 h, 20 h, 25 h or 30 h, but is not limited to the listed values, and other unlisted values within the numerical range are also applicable.

Optionally, the sintering is performed at a heating rate of 1-5° C./min, which may be, for example, 1° C./min, 2° C./min, 3° C./min, 4° C./min or 5° C./min, but is not limited to the listed values, and other unlisted values within the numerical range are also applicable.

Optionally, oxygen is introduced to the sintering in step (3) 1-6 hours before a holding period ends, which may be, for example, 1 h, 2 h, 3 h, 4 h, 5 h or 6 h, but is not limited to the listed values, and other unlisted values within the numerical range are also applicable.

Optionally, oxygen is stopped to be introduced to the sintering in step (3) when temperature is reduced by 100-500° C. after the holding period ends, which may be, for example, 100° C., 200° C., 300° C., 400° C. or 500° C., but is not limited to the listed values, and other unlisted values within the numerical range are also applicable.

Optionally, a preparation method for the first microwave ferrite material in step (1) comprises the following steps:
(a) mixing raw materials for the first microwave ferrite according to a formulation proportion and performing wet ball milling to obtain a ball-milled material; and
(b) drying, sieving and pre-sintering the ball-milled material obtained in step (a) sequentially to obtain the first microwave ferrite material;
wherein the first microwave ferrite material is: Y₃₋ₐCaₐFe_{5-a-b-c}ZrₐIn_{b}Mn_{C}O₁₂, wherein 0≤a≤0.7, 0≤b≤0.7, and 0≤c≤0.7.

Optionally, the raw materials for the first microwave ferrite material are Y₂O₃, CaCO₃, Fe₂O₃, ZrO₂, SnO₂ and MnCO₃.

Optionally, the wet ball milling in step (a) comprises performing the wet ball milling with mixing the raw materials, mill balls, a dispersion medium and a dispersant according to a mass ratio of 1:(4-7.5):(0.6-2.5):(0.003-0.01), which may be, for example, 1:4:0.6:0.003, 1:5:0.8:0.004, 1:6:1.2:0.005, 1:7:1.5:0.006, 1:7.5:2:0.007, 1:5:1.5:0.008, 1:6:2.5:0.009 or 1:6.5:2.5:0.01, but is not limited to the listed values, and other unlisted values within the numerical range are also applicable.

Optionally, the wet ball milling in step (a) is performed at a rotational speed of 20-80 r/min, which may be, for example, 20 r/min, 30 r/min, 40 r/min, 50 r/min, 60 r/min, 70 r/min or 80 r/min, but is not limited to the listed values, and other unlisted values within the numerical range are also applicable.

Optionally, the wet ball milling in step (a) is performed for 10-40 h, which may be, for example, 10 h, 15 h, 20 h, 25 h, 30 h, 35 h or 40 h, but is not limited to the listed values, and other unlisted values within the numerical range are also applicable.

Optionally, the mill balls in step (a) comprise zirconium balls.

Optionally, the mill balls in step (a) comprise large-diameter mill balls and small-diameter mill balls.

The large-diameter mill balls have a diameter of 5-10 mm, which may be, for example, 5 mm, 6 mm, 7 mm, 8 mm, 9 mm or 10 mm, but is not limited to the listed values, and other unlisted values within the numerical range are also applicable.

The small-diameter mill balls have a diameter of 1-4 mm, which may be, for example, 1 mm, 2 mm, 3 mm or 4 mm, but is not limited to the listed values, and other unlisted values within the numerical range are also applicable.

Optionally, a mass ratio of the large-diameter mill balls to the small-diameter mill balls is (0.8-3):1, which may be, for example, 0.8:1, 1:1, 1.2:1, 1.4:1, 1.6:1, 1.8:1, 2:1, 2.2:1, 2.4:1, 2.6:1, 2.8:1 or 3:1, but is not limited to the listed values, and other unlisted values within the numerical range are also applicable.

Optionally, the dispersion medium in step (a) comprises any one or a combination of at least two of deionized water, alcohol, acetone, n-acetone or ammonia, and a typical but not limiting combination comprises a combination of deionized water and alcohol, a combination of deionized water and acetone, a combination of deionized water and ammonia, a combination of deionized water, alcohol and ammonia, or a combination of deionized water, alcohol and acetone.

Optionally, the dispersant used for the wet ball milling in step (a) comprises ammonium citrate and/or ammonia.

Optionally, a particle size range of the ball-milled material in step (a) is: D50=0.05-2 μm and D90=0.05-4 μm, which may be, for example, D50=0.005 μm, 0.01 μm, 0.05 μm, 0.1 μm, 0.5 μm, 1 μm, 1.5 μm or 2 μm, and D90=0.05 μm, 0.1 μm, 0.5 μm, 1 μm, 1.5 μm, 2 μm, 3 μm or 4 μm, but is not limited to the listed values, and other unlisted values within the numerical range are also applicable.

The length of period the wet ball milling takes affects the degree of ionic occupation, and ultimately affects the product performance under the present pre-sintering temperature conditions; different ball milling medium will affect the effect of ball milling, and the selection of mill balls will affect the stability and control difficulty of the process. Through the above optional conditions, a better ball milling effect can be obtained; additionally, in the preparation of the bi-component microwave ferrite, a pure preformed phase of the first microwave ferrite material can be obtained by the ball milling, the impurity phase can be removed, and a suitable particle size distribution and activity can be obtained, which is favorable to the solid-phase reaction in the subsequent pre-sintering and sintering process.

Optionally, the drying in step (b) is performed at 100-150° C., which may be, for example, 100° C., 110° C., 120° C., 130° C., 140° C. or 150° C., but is not limited to the listed values, and other unlisted values within the numerical range are also applicable.

Optionally, the drying in step (b) is stopped when a moisture content is reduced to 0.01-10%, which may be, for example, 0.01%, 1%, 3%, 5%, 7%, 9% or 10%, but is not limited to the listed values, and other unlisted values within the numerical range are also applicable.

Optionally, the sieving in step (b) is performed with a sieve of 30-100 mesh, which may be, for example, 30 mesh, 50 mesh, 70 mesh, 90 mesh or 100 mesh, but is not limited to the listed values, and other unlisted values within the numerical range are also applicable.

Optionally, the pre-sintering in step (b) is performed at 1100-1400° C., which may be, for example, 1100° C., 1200° C., 1300° C. or 1400° C., but is not limited to the listed values, and other unlisted values within the numerical range are also applicable.

Optionally, the pre-sintering in step (b) is performed with a holding period of 6-15 h, which may be, for example, 6 h, 8 h, 10 h, 12 h, 14 h or 15 h, but is not limited to the listed values, and other unlisted values within the numerical range are also applicable.

Optionally, the pre-sintering in step (b) is performed at a heating rate of 0.3-4° C./min, which may be, for example, 0.3° C./min, 1° C./min, 2° C./min, 3° C./min or 4° C./min, but is not limited to the listed values, and other unlisted values within the numerical range are also applicable.

The pre-sintering in the present application can reduce the inhomogeneity in the chemical activity of the dried ball-milled material and also reduce the shrinkage and deformation of the subsequent sintered product.

Optionally, a preparation method for the second microwave ferrite material in step (1) comprises the following steps:
(I) mixing raw materials for the second microwave ferrite according to a formulation proportion and performing wet ball milling to obtain a ball-milled material; and
(II) drying, sieving and pre-sintering the ball-milled material obtained in step (I) sequentially to obtain the second microwave ferrite material;

wherein the second microwave ferrite material is: Gd_{3-A}Ca_{A}Fe_{5-A-B-C}Ge_{A}In_{B}Ti_{C}O₁₂, wherein 0≤A≤0.7, 0≤B≤0.7, and 0≤C≤0.7.

Optionally, the raw materials for the second microwave ferrite material in step (I) are Gd₂O₃, CaCO₃, Fe₂O₃, GeO₂, InO₂ and TiO₂.

Optionally, the wet ball milling in step (I) comprises performing the wet ball milling with mixing the raw materials, mill balls, a dispersion medium and a dispersant according to a mass ratio of 1:(4-7.5):(0.6-2.5):(0.003-0.01), which may be, for example, 1:4:0.6:0.008, 1:5:0.8:0.009, 1:6:1.2:0.01, 1:7:1.5:0.003, 1:7.5:2:0.004, 1:1.5:1.5:0.005, 1:1:2.5:0.006 or 1:5:2.5:0.007, but is not limited to the listed values, and other unlisted values within the numerical range are also applicable.

Optionally, the mill balls for the wet ball milling in step (I) comprise zirconium balls and/or steel balls.

Optionally, the mill balls in step (I) comprise large-diameter mill balls and small-diameter mill balls.

The large-diameter mill balls have a diameter of 5-10 mm, which may be, for example, 5 mm, 6 mm, 7 mm, 8 mm, 9 mm or 10 mm, but is not limited to the listed values, and other unlisted values within the numerical range are also applicable.

The small-diameter mill balls have a diameter of 1-4 mm, which may be, for example, 1 mm, 2 mm, 3 mm or 4 mm, but is not limited to the listed values, and other unlisted values within the numerical range are also applicable.

Optionally, a mass ratio of the large-diameter mill balls to the small-diameter mill balls is (0.8-3):1, which may be, for example, 0.8:1, 1:1, 1.2:1, 1.4:1, 1.6:1, 1.8:1, 2:1, 2.2:1, 2.4:1, 2.6:1, 2.8:1 or 3:1, but is not limited to the listed values, and other unlisted values within the numerical range are also applicable.

Optionally, the dispersion medium in step (I) comprises any one or a combination of at least two of deionized water, alcohol, acetone, n-propanol or ammonia.

Optionally, the dispersant in step (I) comprises ammonium citrate and/or ammonia.

Optionally, the wet ball milling in step (I) is performed at a rotational speed of 20-80 r/min, which may be, for example, 20 r/min, 30 r/min, 40 r/min, 50 r/min, 60 r/min, 70 r/min or 80 r/min, but is not limited to the listed values, and other unlisted values within the numerical range are also applicable.

Optionally, the wet ball milling in step (I) is performed for 10-40 h, which may be, for example, 10 h, 15 h, 20 h, 25 h, 30 h, 35 h or 40 h, but is not limited to the listed values, and other unlisted values within the numerical range are also applicable.

Optionally, a particle size range of the ball-milled material in step (I) is D50=0.005-2 μm and D90=0.05-4 μm, which may be, for example, D50=0.005 μm, 0.01 μm, 0.05 μm, 0.1 μm, 0.5 μm, 1 μm, 1.5 μm or 2 μm, and D90=0.05 μm, 0.1 μm, 0.5 μm, 1 μm, 1.5 μm, 2 μm, 3 μm or 4 μm, but is not limited to the listed values, and other unlisted values within the numerical range are also applicable.

Optionally, the drying in step (II) is performed at 100-150° C., which may be, for example, 100° C., 110° C., 120° C., 130° C., 140° C. or 150° C., but is not limited to the listed values, and other unlisted values within the numerical range are also applicable.

Optionally, the drying in step (II) is stopped when a moisture content is reduced to 0.01-10%, which may be, for example, 0.01%, 0.1%, 1%, 3%, 5%, 7%, 9% or 10%, but is not limited to the listed values, and other unlisted values within the numerical range are also applicable.

Optionally, the sieving in step (II) is performed with a sieve of 30-100 mesh, which may be, for example, 30 mesh, 40 mesh, 50 mesh, 60 mesh, 70 mesh, 80 mesh, 90 mesh or 100 mesh, but is not limited to the listed values, and other unlisted values within the numerical range are also applicable.

Optionally, the pre-sintering in step (II) is performed at 1100-1400° C., which may be, for example, 1100° C., 1200° C., 1300° C. or 1400° C., but is not limited to the listed values, and other unlisted values within the numerical range are also applicable.

Optionally, the pre-sintering in step (II) is performed with a holding period of 8-20 h, which may be, for example, 8 h, 10 h, 12 h, 14 h, 16 h, 18 h or 20 h, but is not limited to the listed values, and other unlisted values within the numerical range are also applicable.

Optionally, the pre-sintering in step (II) is performed at a heating rate of 0.3-4° C./min, which may be, for example, 0.3° C./min, 2° C./min, 3° C./min or 4° C./min, but is not limited to the listed values, and other unlisted values within the numerical range are also applicable.

The pre-sintering in the present application can reduce the inhomogeneity in the chemical activity of the dried ball-milled material and also reduce the shrinkage and deformation of the subsequent sintered product.

As an optional technical solution of the present application, the preparation method as described in the second aspect comprises the following steps:
(1) mixing the first microwave ferrite material and the second microwave ferrite material according to a formulation proportion, and then performing wet ball milling to obtain a ball-milled material; the wet ball milling is performed with a rotational speed of 20-80 r/min for 10-40 h by mixing the raw materials, mill balls and a dispersion medium according to a mass ratio of 1:(4-7.5):(0.6-2.5); a particle size range of the ball-milled material is: D50=0.005-2 μm and D90=0.05-4 μm;
(2) drying the ball-milled material obtained in step (1) at 100-250° C. until a moisture content is reduced to 0.01-10%, sieving with a sieve of 30-100 mesh and performing granulation;
wherein the granulation comprises uniformly mixing a sieved ball-milled material and a binder, and sieving with a sieve of 30-100 mesh at a pressure of 300-1200 kg/cm² to obtain granulated particles;
(3) molding and sintering the granulated particles in step (2) sequentially to obtain the high-saturation low-loss bi-component microwave ferrite material; the molding comprises compressing the granulated particles obtained in step (2) in a mold into a blank having a prescribed shape, and the blank has a molding density of 3.0-4.0 g/cm³; the sintering is performed at 1200-1500° C. with a heating rate of 1-5° C./min, the sintering has a holding period of 5-30 h, and oxygen is introduced to the sintering 1-6 hours before the holding period ends, and after the holding period ends, oxygen is stopped to be introduced when temperature is reduced by 100-500° C.;
a preparation method for the first microwave ferrite material in step (1) comprises:
   (a) mixing raw materials for the first microwave ferrite according to a formulation proportion and performing wet ball milling to obtain a ball-milled material; the wet ball milling is performed with a rotational speed of 20-80 r/min for 10-40 h; a particle size range of the obtained ball-milled material is: D50=0.005-2 μm, and D90=0.05-4 μm; and
   (b) drying, sieving with a sieve of 30-100 mesh, and pre-sintering the ball-milled material obtained in step (a) sequentially to obtain the first microwave ferrite material; the drying is performed at 100-250° C. and stopped when a moisture content is reduced to 0.01-10%; the pre-sintering is performed at 1100-1350° C.; the pre-sintering has a holding period of 6-15 h; the pre-sintering is performed at a heating rate of 0.3-4° C./min;
a preparation method for the second microwave ferrite material in step (1) comprises:
(I) mixing raw materials for the second microwave ferrite according to a formulation proportion and performing wet ball milling to obtain a ball-milled material; the wet ball milling is performed with a rotational speed of 20-80 r/min for 10-40 h; a particle size range of the obtained ball-milled material is: D50=0.005-2 μm, and D90=0.05-4 μm; and
(II) drying, sieving and pre-sintering the ball-milled material obtained in step (I) sequentially to obtain the second microwave ferrite material; the drying is performed at 100-250° C. and stopped when a moisture content is reduced to 0.01-10%; the pre-sintering is performed at 1100-1400° C.; the pre-sintering is performed with a holding period of 8-20 h.

In a third aspect, the present application provides use of the high-saturation low-loss bi-component microwave ferrite material as described in the first aspect, and wherein the high-saturation low-loss bi-component microwave ferrite material is used for a microwave communication device.

The numerical ranges in the present application includes not only the above listed point values, but also any unlisted point values within the numerical ranges; due to the space limitation and concision consideration, the specific point values included in the ranges will not be enumerated exhaustively in the present application.

Compared with the prior art, the beneficial effects of the present application include:
(1) the microwave ferrite material prepared by the bi-component composite process in the present application has a high saturation magnetization, high Curie temperature, low linewidth, and low loss; the saturation magnetization is 1950 Gs-1960 Gs, the dielectric loss is 1.58×10⁻⁴-2×10⁻⁴, the Curie temperature can reach 260° C. or more, and the linewidth is less than 18 Oe; and
(2) the preparation method in the present application is stable and repeatable, which is conducive to industrialized production.

### DETAILED DESCRIPTION

The technical solutions of the present application are further described below in terms of specific examples.

### Example 1

This example provides a high-saturation low-loss bi-component microwave ferrite material, and the high-saturation low-loss bi-component microwave ferrite material comprises a first microwave ferrite material and a second microwave ferrite material.

The first microwave ferrite material is: Y₃₋ₐCaₐFe_{5-a-b-c}ZrₐIn_{b}Mn_{c}O₁₂, wherein σ=0.3, b=0.3, and c=0; and

the second microwave ferrite material is: Gd_{3-A}Ca_{A}Fe_{5-A-B-C}Ge_{A}In_{B}Ti_{C}O₁₂, wherein A=0.5, B=0.1, and C=0.05.

A preparation method for the high-saturation low-loss bi-component microwave ferrite material comprises the following steps:
(1) the first microwave ferrite material and the second microwave ferrite material were uniformly mixed according to a mass ratio of 1:1, and subjected to wet ball milling to obtain a ball-milled material; the wet ball milling was performed with a rotational speed of 20 r/min for 26 h by mixing the raw materials, zirconium balls and deionized water according to a mass ratio of 1:4:0.6; a mass ratio of large-diameter zirconium balls to small-diameter zirconium balls was 3:1, and the large-diameter zirconium balls had a diameter of 5 mm and the small-diameter zirconium balls had a diameter of 2 mm; a particle size range of the obtained ball-milled material was: D50=0.85 μm and D90=2.85 μm;
(2) the ball-milled material obtained in step (1) was dried at 120° C. until a moisture content was reduced to 5.5%, and then sieved with a 30-mesh sieve and subjected to granulation; the granulation included the process that the sieved ball-milled material and a binder were mixed uniformly and then sieved with a 30-mesh sieve under a pressure of 1200 kg/cm² to obtain granulated particles; the binder was an aqueous solution of polyvinyl alcohol, the aqueous solution of polyvinyl alcohol had a concentration of 20 wt %, and the aqueous solution of polyvinyl alcohol was 5% by mass of the sieved ball-milled material; and
(3) the granulated particles in step (2) were molded and sintered sequentially to obtain the high-saturation low-loss bi-component microwave ferrite material; the molding included the process that the granulated particles obtained in step (2) were compressed in a mold into a blank having a prescribed shape, and the blank had a molding density of 3.5 g/cm³; the sintering was performed at 1250° C. with a heating rate of 1° C./min, the sintering had a holding period of 5 h, and oxygen was introduced to the sintering 3 hours before the holding period ended, and after the holding period ended, oxygen was stopped to be introduced when temperature was reduced by 200° C.;
a preparation method for the first microwave ferrite material in step (1) comprises:
(a) raw materials for the first microwave ferrite were mixed according to a formulation proportion, and the raw materials, mill balls, deionized water and ammonium citrate were mixed according to a mass ratio of 1:4:0.6:0.003, and subjected to wet ball milling for 16 h with a rotational speed of 20 r/min; a mass ratio of large-diameter mill balls to small-diameter mill balls was 3:1; the large-diameter mill balls had a diameter of 5 mm, and the small-diameter mill balls had a diameter of 2 mm; a particle size range of the obtained ball-milled material was D50=0.85 μm and D90=2.85 μm; and
(b) the ball-milled material obtained in step (a) was sequentially dried, sieved with a 30-mesh sieve and pre-sintered to obtain the first microwave ferrite material; the drying was performed at 120° C. and stopped when a moisture content was reduced to 0.2%; the pre-sintering was performed at 1150° C. with a heating rate of 0.5° C./min, and the pre-sintering had a holding period of 6 h;
a preparation method for the second microwave ferrite material in step (1) comprises:
(I) raw materials for the second microwave ferrite material were mixed according to a formulation proportion, the raw materials, mill balls, deionized water and ammonium citrate were mixed according to a mass ratio of 1:4:0.6:0.003, and subjected to wet ball milling for 16 h with a rotational speed of 20 r/min; a mass ratio of large-diameter mill balls to small-diameter mill balls was 3:1; the large-diameter mill balls had a diameter of 5 mm, and the small-diameter mill balls had a diameter of 2 mm; a particle size range of the obtained ball-milled material was D50=0.85 μm and D90=2.85 μm; and
(II) the ball-milled material obtained in step (I) was sequentially dried, sieved and pre-sintered to obtain the second microwave ferrite material; the drying was performed at 100° C. and stopped when a moisture content was reduced to 0.5%; the pre-sintering was performed at 1120° C.; the pre-sintering had a holding period of 8 h.

The obtained sample was ground and then tested for the magnetic properties as shown in Table 1.

### Example 2

This example provides a high-saturation low-loss bi-component microwave ferrite material, and the high-saturation low-loss bi-component microwave ferrite material comprises a first microwave ferrite material and a second microwave ferrite material.

The first microwave ferrite material is: Y₃₋ₐCaₐFe_{5-a-b-c}ZrₐIn_{b}Mn_{c}O₁₂, wherein σ=0.2, b=0.4, and c=0.05; and

the second microwave ferrite material is: Gd_{3-A}Ca_{A}Fe_{5-A-B-C}Ge_{A}In_{B}Ti_{C}O₁₂, wherein A=0.2, B=0.3, and C=0.3.

A preparation method for the high-saturation low-loss bi-component microwave ferrite material comprises the following steps:
(1) the first microwave ferrite material and the second microwave ferrite material were uniformly mixed according to a mass ratio of 1:1, and subjected to wet ball milling to obtain a ball-milled material; the wet ball milling was performed with a rotational speed of 40 r/min for 15 h by mixing the raw materials, zirconium balls and acetone according to a mass ratio of 1:6:1.3; a mass ratio of large-diameter zirconium balls to small-diameter zirconium balls was 5:2, and the large-diameter zirconium balls had a diameter of 10 mm and the small-diameter zirconium balls had a diameter of 4 mm; a particle size range of the obtained ball-milled material was: D50=1.2 μm and D90=1.5 μm;
(2) the ball-milled material obtained in step (1) was dried at 150° C. until a moisture content was reduced to 6.5%, and then sieved with a 50-mesh sieve and subjected to granulation; the granulation included the process that the sieved ball-milled material and a binder were mixed uniformly and then sieved with a 50-mesh sieve under a pressure of 1000 kg/cm² to obtain granulated particles; the binder was an aqueous solution of polyvinyl alcohol, the aqueous solution of polyvinyl alcohol had a concentration of 10 wt %, and the aqueous solution of polyvinyl alcohol was 6% by mass of the sieved ball-milled material; and
(3) the granulated particles in step (2) were molded and sintered sequentially to obtain the high-saturation low-loss bi-component microwave ferrite material; the molding included the process that the granulated particles obtained in step (2) were compressed in a mold into a blank having a prescribed shape, and the blank had a molding density of 4 g/cm³; the sintering was performed at 1260° C. with a heating rate of 3° C./min, the sintering had a holding period of 10 h, and oxygen was introduced to the sintering 4 hours before the holding period ended, and after the holding period ended, oxygen was stopped to be introduced when temperature was reduced by 300° C.;
a preparation method for the first microwave ferrite material in step (1) comprises:
   (a) raw materials for the first microwave ferrite were mixed according to a formulation proportion, and the raw materials, zirconium balls, alcohol and ammonium citrate were mixed according to a mass ratio of 1:5.5:1.2:0.005, and subjected to wet ball milling for 15 h with a rotational speed of 30 r/min; a mass ratio of large-diameter mill balls to small-diameter mill balls was 4:1.5; the large-diameter mill balls had a diameter of 5 mm, and the small-diameter mill balls had a diameter of 3 mm; a particle size range of the obtained ball-milled material was D50=1 μm and D90=3 m; and
   (b) the ball-milled material obtained in step (a) was sequentially dried, sieved with a 50-mesh sieve and pre-sintered to obtain the first microwave ferrite material; the drying was performed at 150° C. and stopped when a moisture content was reduced to 5.5%; the pre-sintering was performed at 1100° C. with a heating rate of 3.2° C./min, and the pre-sintering had a holding period of 7 h;
a preparation method for the second microwave ferrite material in step (1) comprises:
(I) raw materials for the second microwave ferrite material were mixed according to a formulation proportion, the raw materials, zirconium balls, alcohol and ammonium citrate were mixed according to a mass ratio of 1:5.5:1.2:0.005, and subjected to wet ball milling for 15 h with a rotational speed of 30 r/min; a mass ratio of large-diameter mill balls to small-diameter mill balls was 4:1.5; the large-diameter mill balls had a diameter of 5 mm, and the small-diameter mill balls had a diameter of 3 mm; a particle size range of the obtained ball-milled material was D50=1 μm and D90=3 km; and
(II) the ball-milled material obtained in step (I) was sequentially dried, sieved with a 50-mesh sieve and pre-sintered to obtain the second microwave ferrite material; the drying was performed at 150° C. and stopped when a moisture content was reduced to 3.2%; the pre-sintering was performed at 1100° C.; the pre-sintering had a holding period of 9 h.

The obtained sample was ground and then tested for the magnetic properties as shown in Table 1.

### Example 3

This example provides a high-saturation low-loss bi-component microwave ferrite material, and the high-saturation low-loss bi-component microwave ferrite material comprises a first microwave ferrite material and a second microwave ferrite material.

The first microwave ferrite material is: Y₃₋ₐCaₐFe_{5-a-b-c}ZrₐIn_{b}Mn_{c}O₁₂, wherein σ=0.25, b=0.25, and c=0.1; and

the second microwave ferrite material is: Gd_{3-A}Ca_{A}Fe_{5-A-B-C}Ge_{A}In_{B}Ti_{C}O₁₂, wherein A=0.2, B=0.5, and C=0.4.

A preparation method for the high-saturation low-loss bi-component microwave ferrite material comprises the following steps:
(1) the first microwave ferrite material and the second microwave ferrite material were uniformly mixed according to a mass ratio of 1:1, and subjected to wet ball milling to obtain a ball-milled material; the wet ball milling was performed with a rotational speed of 60 r/min for 20 h by mixing the raw materials, zirconium balls and acetone according to a mass ratio of 1:6:1.4; a mass ratio of large-diameter zirconium balls to small-diameter zirconium balls was 1:1, and the large-diameter zirconium balls had a diameter of 3 mm and the small-diameter zirconium balls had a diameter of 3 mm; a particle size range of the obtained ball-milled material was: D50=0.5 μm and D90=4 μm;
(2) the ball-milled material obtained in step (1) was dried at 200° C. until a moisture content was reduced to 0.01%, and then sieved with a 80-mesh sieve and subjected to granulation; the granulation included the process that the sieved ball-milled material and a binder were mixed uniformly and then sieved with a 50-mesh sieve under a pressure of 1000 kg/cm² to obtain granulated particles; the binder was an aqueous solution of polyvinyl alcohol, the aqueous solution of polyvinyl alcohol had a concentration of 5 wt %, and the aqueous solution of polyvinyl alcohol was 8% by mass of the sieved ball-milled material; and
(3) the granulated particles in step (2) were molded and sintered sequentially to obtain the high-saturation low-loss bi-component microwave ferrite material; the molding included the process that the granulated particles obtained in step (2) were compressed in a mold into a blank having a prescribed shape, and the blank had a molding density of 3.2 g/cm³; the sintering was performed at 1400° C. with a heating rate of 3.5° C./min, the sintering had a holding period of 15 h, and oxygen was introduced to the sintering 2 hours before the holding period ended, and after the holding period ended, oxygen was stopped to be introduced when temperature was reduced by 400° C.;
a preparation method for the first microwave ferrite material in step (1) comprises:
(a) raw materials for the first microwave ferrite were mixed according to a formulation proportion, and the raw materials, zirconium balls, acetone and ammonium citrate were mixed according to a mass ratio of 1:7:1.3:0.006, and subjected to wet ball milling for 10 h with a rotational speed of 40 r/min; a mass ratio of large-diameter mill balls to small-diameter mill balls was 5:2; the large-diameter mill balls had a diameter of 10 mm, and the small-diameter mill balls had a diameter of 4 mm; a particle size range of the obtained ball-milled material was D50=1.2 μm and D90=2.5 μm; and
(b) the ball-milled material obtained in step (a) was sequentially dried, sieved with a 50-mesh sieve and pre-sintered to obtain the first microwave ferrite material; the drying was performed at 200° C. and stopped when a moisture content was reduced to 0.01%; the pre-sintering was performed at 1250° C. with a heating rate of 2.8° C./min, and the pre-sintering had a holding period of 8 h;
a preparation method for the second microwave ferrite material in step (1) comprises:
(I) raw materials for the second microwave ferrite material were mixed according to a formulation proportion, the raw materials, zirconium balls, acetone and ammonium citrate were mixed according to a mass ratio of 1:7:1.3:0.006, and subjected to wet ball milling for 10 h with a rotational speed of 40 r/min; a mass ratio of large-diameter mill balls to small-diameter mill balls was 5:2; the large-diameter mill balls had a diameter of 10 mm, and the small-diameter mill balls had a diameter of 4 mm; a particle size range of the obtained ball-milled material was D50=1.2 μm and D90=2.5 μm; and
(II) the ball-milled material obtained in step (I) was sequentially dried, sieved with a 50-mesh sieve and pre-sintered to obtain the second microwave ferrite material; the drying was performed at 200° C. and stopped when a moisture content was reduced to 0.01%; the pre-sintering was performed at 1120° C.; the pre-sintering had a holding period of 7 h.

The obtained sample was ground and then tested for the magnetic properties as shown in Table 1.

### Example 4

This example provides a high-saturation low-loss bi-component microwave ferrite material, and the high-saturation low-loss bi-component microwave ferrite material comprises a first microwave ferrite material and a second microwave ferrite material.

The first microwave ferrite material is: Y₃₋ₐCaₐFe_{5-a-b-c}ZrₐIn_{b}Mn_{c}O₁₂, wherein σ=0.35, b=0.15, and c=0.1; and
the second microwave ferrite material is: Gd_{3-A}Ca_{A}Fe_{5-A-B-C}Ge_{A}In_{B}Ti_{C}O₁₂, wherein A=0.4, B=0.2, and C=0.4.

A preparation method for the high-saturation low-loss bi-component microwave ferrite material comprises the following steps:
(1) the first microwave ferrite material and the second microwave ferrite material were uniformly mixed according to a mass ratio of 1:1, and subjected to wet ball milling to obtain a ball-milled material; the wet ball milling was performed with a rotational speed of 80 r/min for 40 h by mixing the raw materials, zirconium balls and acetone according to a mass ratio of 1:7.5:2.5; a mass ratio of large-diameter zirconium balls to small-diameter zirconium balls was 3.5:4, and the large-diameter zirconium balls had a diameter of 7 mm and the small-diameter zirconium balls had a diameter of 1 mm; a particle size range of the obtained ball-milled material was: D50=0.3 μm and D90=2 μm;
(2) the ball-milled material obtained in step (1) was dried at 200° C. until a moisture content was reduced to 8%, and then sieved with a 100-mesh sieve and subjected to granulation; the granulation included the process that the sieved ball-milled material and a binder were mixed uniformly and then sieved with a 100-mesh sieve under a pressure of 300 kg/cm² to obtain granulated particles; the binder was an aqueous solution of polyvinyl alcohol, the aqueous solution of polyvinyl alcohol had a concentration of 8 wt %, and the aqueous solution of polyvinyl alcohol was 7% by mass of the sieved ball-milled material; and
(3) the granulated particles in step (2) were molded and sintered sequentially to obtain the high-saturation low-loss bi-component microwave ferrite material; the molding included the process that the granulated particles obtained in step (2) were compressed in a mold into a blank having a prescribed shape, and the blank had a molding density of 3 g/cm³; the sintering was performed at 1500° C. with a heating rate of 4.8° C./min, the sintering had a holding period of 20 h, and oxygen was introduced to the sintering 1 hour before the holding period ended, and after the holding period ended, oxygen was stopped to be introduced when temperature was reduced by 500° C.;
a preparation method for the first microwave ferrite material in step (1) comprises:
(a) raw materials for the first microwave ferrite were mixed according to a formulation proportion, and the raw materials, zirconium balls, acetone and ammonium citrate were mixed according to a mass ratio of 1:6:1.4:0.01, and subjected to wet ball milling for 20 h with a rotational speed of 60 r/min; a mass ratio of large-diameter mill balls to small-diameter mill balls was 1:1; the large-diameter mill balls had a diameter of 6 mm, and the small-diameter mill balls had a diameter of 2 mm; a particle size range of the obtained ball-milled material was D50=0.5 μm and D90=4 μm; and
(b) the ball-milled material obtained in step (a) was sequentially dried, sieved with a 100-mesh sieve and pre-sintered to obtain the first microwave ferrite material; the drying was performed at 250° C. and stopped when a moisture content was reduced to 6.9%; the pre-sintering was performed at 1300° C. with a heating rate of 5.2° C./min, and the pre-sintering had a holding period of 10 h;
a preparation method for the second microwave ferrite material in step (1) comprises:
(I) raw materials for the second microwave ferrite material were mixed according to a formulation proportion, the raw materials, zirconium balls, n-acetone and ammonium citrate were mixed according to a mass ratio of 1:6:1.4:0.01, and subjected to wet ball milling for 20 h with a rotational speed of 60 r/min; a mass ratio of large-diameter mill balls to small-diameter mill balls was 1:1; the large-diameter mill balls had a diameter of 6 mm, and the small-diameter mill balls had a diameter of 2 mm; a particle size range of the obtained ball-milled material was D50=0.5 μm and D90=4 μm; and
(II) the ball-milled material obtained in step (I) was sequentially dried, sieved with a 100-mesh sieve and pre-sintered to obtain the second microwave ferrite material; the drying was performed at 250° C. and stopped when a moisture content was reduced to 8.2%; the pre-sintering was performed at 1250° C.; the pre-sintering had a holding period of 15 h.

The obtained sample was ground and then tested for the magnetic properties as shown in Table 1.

### Example 5

This example provides a high-saturation low-loss bi-component microwave ferrite material, and the high-saturation low-loss bi-component microwave ferrite material comprises a first microwave ferrite material and a second microwave ferrite material.

The first microwave ferrite material is: Y₃₋ₐCa_{ab}Fe_{5-a-b-c}ZrₐIn_{b}Mn_{c}O₁₂, wherein σ=0.4, b=0.1, and c=0.35; and

the second microwave ferrite material is: Gd_{3-A}Ca_{A}Fe_{5-A-B-C}Ge_{A}In_{B}Ti_{C}O₁₂, wherein A=0.6, B=0.5, and C=0.3.

A preparation method for the high-saturation low-loss bi-component microwave ferrite material comprises the following steps:
(1) the first microwave ferrite material and the second microwave ferrite material were uniformly mixed according to a mass ratio of 1:1, and subjected to wet ball milling to obtain a ball-milled material; the wet ball milling was performed with a rotational speed of 30 r/min for 10 h by mixing the raw materials, zirconium balls and acetone according to a mass ratio of 1:5.5:2.5; a mass ratio of large-diameter zirconium balls to small-diameter zirconium balls was 4:1.5, and the large-diameter zirconium balls had a diameter of 5 mm and the small-diameter zirconium balls had a diameter of 3 mm; a particle size range of the obtained ball-milled material was: D50=1 μm and D90=3 μm;
(2) the ball-milled material obtained in step (1) was dried at 180° C. until a moisture content was reduced to 10%, and then sieved with a 60-mesh sieve and subjected to granulation; the granulation included the process that the sieved ball-milled material and a binder were mixed uniformly and then sieved with a 6-mesh sieve under a pressure of 800 kg/cm² to obtain granulated particles; the binder was an aqueous solution of polyvinyl alcohol, the aqueous solution of polyvinyl alcohol had a concentration of 5 wt %, and the aqueous solution of polyvinyl alcohol was 10% by mass of the sieved ball-milled material; and
(3) the granulated particles in step (2) were molded and sintered sequentially to obtain the high-saturation low-loss bi-component microwave ferrite material; the molding included the process that the granulated particles obtained in step (2) were compressed in a mold into a blank having a prescribed shape, and the blank had a molding density of 3.6 g/cm³; the sintering was performed at 1200° C. with a heating rate of 3.9° C./min, the sintering had a holding period of 30 h, and oxygen was introduced to the sintering 6 hours before the holding period ended, and after the holding period ended, oxygen was stopped to be introduced when temperature was reduced by 100° C.;
a preparation method for the first microwave ferrite material in step (1) comprises:
(a) raw materials for the first microwave ferrite were mixed according to a formulation proportion, and the raw materials, zirconium balls, ammonia and ammonium citrate were mixed according to a mass ratio of 1:7.5:2.5:0.008, and subjected to wet ball milling for 40 h with a rotational speed of 80 r/min; a mass ratio of large-diameter mill balls to small-diameter mill balls was 3.5:4; the large-diameter mill balls had a diameter of 7 mm, and the small-diameter mill balls had a diameter of 4 mm; a particle size range of the obtained ball-milled material was D50=0.3 μm and D90=2 μm; and
(b) the ball-milled material obtained in step (a) was sequentially dried, sieved with a 60-mesh sieve and pre-sintered to obtain the first microwave ferrite material; the drying was performed at 180° C. and stopped when a moisture content was reduced to 6.9%; the pre-sintering was performed at 1350° C. with a heating rate of 4.2° C./min, and the pre-sintering had a holding period of 15 h;
a preparation method for the second microwave ferrite material in step (1) comprises:
(I) raw materials for the second microwave ferrite material were mixed according to a formulation proportion, the raw materials, zirconium balls, alcohol and ammonia were mixed according to a mass ratio of 1:7.5:2.5:0.008, and subjected to wet ball milling for 40 h with a rotational speed of 80 r/min; a mass ratio of large-diameter mill balls to small-diameter mill balls was 3.5:4; the large-diameter mill balls had a diameter of 7 mm, and the small-diameter mill balls had a diameter of 4 mm; a particle size range of the obtained ball-milled material was D50=0.3 μm and D90=2 μm; and
(II) the ball-milled material obtained in step (I) was sequentially dried, sieved with a 100-mesh sieve and pre-sintered to obtain the second microwave ferrite material; the drying was performed at 250° C. and stopped when a moisture content was reduced to 8.2%; the pre-sintering was performed at 1250° C.; the pre-sintering had a holding period of 15 h.

The obtained sample was ground and then tested for the magnetic properties as shown in Table 1.

### Example 6

This example provides a high-saturation low-loss bi-component microwave ferrite material, and a preparation method for the high-saturation low-loss bi-component microwave ferrite material is the same as that of Example 1 except that the mass ratio of the first microwave ferrite material and the second microwave ferrite material in step (1) was changed to 1:3.

The obtained sample was ground and then tested for the magnetic properties as shown in Table 1.

### Example 7

This example provides a high-saturation low-loss bi-component microwave ferrite material, and a preparation method for the high-saturation low-loss bi-component microwave ferrite material is the same as that of Example 1 except that the mass ratio of the first microwave ferrite material and the second microwave ferrite material in step (1) was changed to 3:1.

The obtained sample was ground and then tested for the magnetic properties as shown in Table 1.

### Example 8

This example provides a high-saturation low-loss bi-component microwave ferrite material, and the high-saturation low-loss bi-component microwave ferrite material comprises a first microwave ferrite material and a second microwave ferrite material.

The first microwave ferrite material is: Y₃₋ₐCaₐFe_{5-a-b-c}ZrₐIn_{b}Mn_{c}O₁₂, wherein σ=0, b=0, and c=0; and

the second microwave ferrite material is: Gd_{3-A}Ca_{A}Fe_{5-A-B-C}Ge_{A}In_{B}Ti_{C}O₁₂, wherein A=0, B=0, and C=0.

A preparation method for the high-saturation low-loss bi-component microwave ferrite material is the same as that of Example 1.

The obtained sample was ground and then tested for the magnetic properties as shown in Table 1.

### Example 9

This example provides a high-saturation low-loss bi-component microwave ferrite material, and a preparation method for the high-saturation low-loss bi-component microwave ferrite material is the same as that of Example 1 except that the sintering in step (3) was performed at 800° C. instead.

The obtained sample was ground and then tested for the magnetic properties as shown in Table 1.

### Example 10

This example provides a high-saturation low-loss bi-component microwave ferrite material, and a preparation method for the high-saturation low-loss bi-component microwave ferrite material is the same as that of Example 1 except that the sintering in step (3) was performed at 2000° C. instead.

The obtained sample was ground and then tested for the magnetic properties as shown in Table 1.

### Comparative Example 1

This comparative example provides a microwave ferrite material, and the microwave ferrite material is: Y_{3-a-b}Ca_{a+b}Fe_{5-a-b-c}ZrₐIn_{b}Mn_{C}O₁₂, wherein σ=0.3, b=0.3, and c=0.

A preparation method for the microwave ferrite comprises the following steps:
(1) raw materials for the microwave ferrite material were mixed according to a formulation proportion, and the raw materials, mill balls, deionized water and ammonium citrate were mixed according to a mass ratio of 1:4:0.6:0.003, and subjected to wet ball milling for 16 h with a rotational speed of 20 r/min; a mass ratio of large-diameter mill balls to small-diameter mill balls was 3:1; the large-diameter mill balls had a diameter of 5 mm, and the small-diameter mill balls had a diameter of 2 mm; a particle size range of the obtained ball-milled material was D50=0.85 μm and D90=2.85 μm;
(2) the ball-milled material obtained in step (1) was sequentially dried, sieved with a 30-mesh sieve and pre-sintered to obtain a microwave ferrite material precursor; the drying was performed at 120° C. and stopped when a moisture content was reduced to 0.2%; the pre-sintering was performed at 1150° C. with a heating rate of 0.5° C./min, and the pre-sintering had a holding period of 6 h;
(3) the microwave ferrite material precursor obtained in step (1) was crushed to obtain a powder, and the powder was sieved with a 30-mesh sieve and then mixed with zirconium balls and deionized water according to a mass ratio of 1:4:0.6 and subjected to wet ball milling for 26 h with a rotational speed of 20 r/min; a mass ratio of large-diameter zirconium balls to small-diameter zirconium balls was 3:1; the large-diameter zirconium balls had a diameter of 5 mm, and the small-diameter zirconium balls had a diameter of 2 mm; a particle size range of the obtained ball-milled material was D50=0.85 μm and D90=2.85 μm;
(4) the ball-milled material obtained in step (3) was dried at 120° C. until a moisture content was reduced to 5.5%, and then sieved with a 30-mesh sieve and subjected to granulation; the granulation included the process that the sieved ball-milled material and a binder were mixed uniformly and then sieved with a 30-mesh sieve under a pressure of 1200 kg/cm² to obtain granulated particles; the binder was an aqueous solution of polyvinyl alcohol, the aqueous solution of polyvinyl alcohol had a concentration of 20 wt %, and the aqueous solution of polyvinyl alcohol was 5% by mass of the sieved ball-milled material; and
(5) the granulated particles in step (4) were molded and sintered sequentially to obtain the high-saturation low-loss bi-component microwave ferrite material; the molding included the process that the granulated particles obtained in step (4) were compressed in a mold into a blank having a prescribed shape, and the blank had a molding density of 3.5 g/cm³; the sintering was performed at 1250° C. with a heating rate of 1° C./min, the sintering had a holding period of 5 h, and oxygen was introduced to the sintering 3 hours before the holding period ended, and after the holding period ended, oxygen was stopped to be introduced when temperature was reduced by 200° C.

The obtained sample was ground and then tested for the magnetic properties as shown in Table 1.

### Comparative Example 2

This comparative example provides a microwave ferrite material, and the microwave ferrite material is: Gd_{3-A-B}Ca_{A+B}Fe_{5-A-B-C}Ge_{A}In_{B}Ti_{C}O₁₂, wherein A=0.5, B=0.1, and C=0.05.

A preparation method provided in this comparative example is the same as that of Comparative Example 1.

The obtained sample was ground and then tested for the magnetic properties as shown in Table 1.

### Comparative Example 3

Based on the ionic substitution mechanism, this comparative example provides a microwave ferrite material, and the microwave ferrite material is: Y_{1.5}Ca_{1.2}Fe_{3.9}V_{0.6}Al_{0.2}Zr_{0.3}In_{0.3}Mn_{0.1}O₁₂.

A preparation method for the microwave ferrite comprises the following steps:
(1) raw materials were weighed out according to the calculation based on the formulation; the raw materials weighed out were put into a ball mill jar and mixed with zirconium balls, deionized water and ammonium citrate according to a mass ratio of 1:4:1:0.1, and subjected to wet ball milling for 16 h with a rotational speed of 20 r/min; a mass ratio of large-diameter zirconium balls to small-diameter zirconium balls was 3:1; the large-diameter zirconium balls had a diameter of 5 mm, and the small-diameter zirconium balls had a diameter of 2 mm; a particle size range of the obtained ball-milled material was D50=0.85 μm and D90=2.85 μm;
(2) the ball-milled material obtained in step (1) was sequentially dried, sieved with a 30-mesh sieve and pre-sintered; the drying was performed at 100° C. and stopped when a moisture content was reduced to 0.5%; the pre-sintering was performed at 1150° C. with a heating rate of 2.6° C./min, and the pre-sintering had a holding period of 6 h;
(3) the pre-sintered ball-milled material obtained in step (2) was crushed to obtain a powder, and the powder was sieved with a 30-mesh sieve and then mixed with zirconium balls and deionized water according to a mass ratio of 1:4:1 and subjected to wet ball milling for 26 h with a rotational speed of 20 r/min; a mass ratio of large-diameter zirconium balls to small-diameter zirconium balls was 3:1; the large-diameter zirconium balls had a diameter of 5 mm, and the small-diameter zirconium balls had a diameter of 2 mm; a particle size range of the obtained ball-milled material was D50=0.85 μm and D90=2.85 μm;
(4) the ball-milled material obtained in step (3) was dried at 250° C. until a moisture content was reduced to 8%, and then sieved with a 40-mesh sieve and subjected to granulation; the granulation included the process that the sieved ball-milled material and a binder were mixed uniformly and then sieved with a 30-mesh sieve under a pressure of 300 kg/cm² to obtain granulated particles; the binder was a polypropylene glycol solution with a concentration of 5 wt %, and the polypropylene glycol solution was 7% by mass of the dried ball-milled material in step (3); and
(5) the granulated particles in step (4) were molded and sintered sequentially to obtain the bi-component microwave ferrite material; the molding included the process that the granulated particles obtained in step (4) were compressed in a mold into a round blank, and the round blank had a molding density of 3.8 g/cm³; the sintering was performed at 1500° C. with a heating rate of 0.8° C./min, the sintering had a holding period of 10 h, and oxygen was introduced to the sintering 6 hours before the holding period ended, and after the holding period ended, oxygen was stopped to be introduced when temperature was reduced to 1000° C.

The obtained sample was ground and then tested for the magnetic properties as shown in Table 1.

### Comparative Example 4

Based on the ionic substitution mechanism, this comparative example provides a microwave ferrite material, and the microwave ferrite material is:
Y_{2.56}Ca_{0.35}Fe_{4.6}Sn_{0.35}Mn_{0.05}O₂.

A preparation method for the microwave ferrite comprises the following steps:
(1) raw materials were weighed out according to the calculation based on the formulation; the raw materials weighed out were put into a ball mill jar and mixed with mill balls, deionized water and ammonium citrate according to a mass ratio of 1:5.5:1.2:0.03, and subjected to wet ball milling for 10 h with a rotational speed of 10 r/min; a mass ratio of large-diameter zirconium balls to small-diameter zirconium balls was 4:1.5; the large-diameter zirconium balls had a diameter of 5 mm, and the small-diameter zirconium balls had a diameter of 3 mm; a particle size range of the obtained ball-milled material was D50=1 μm and D90=3 μm;
(2) the ball-milled material obtained in step (1) was sequentially dried, sieved with a 30-mesh sieve and pre-sintered; the drying was performed at 100° C. and stopped when a moisture content was reduced to 0.5%; the pre-sintering was performed at 1180° C. with a heating rate of 1.8° C./min, and the pre-sintering had a holding period of 7 h;
(3) the pre-sintered ball-milled material obtained in step (2) was crushed to obtain a powder, and the powder was sieved with a 30-mesh sieve and then mixed with zirconium balls and deionized water according to a mass ratio of 1:6:1.3 and subjected to wet ball milling for 8 h with a rotational speed of 40 r/min; a mass ratio of large-diameter zirconium balls to small-diameter zirconium balls was 5:2; the large-diameter zirconium balls had a diameter of 10 mm, and the small-diameter zirconium balls had a diameter of 4 mm; a particle size range of the obtained ball-milled material was D50=1.2 μm and D90=2.5 μm;
(4) the ball-milled material obtained in step (3) was dried at 250° C. until a moisture content was reduced to 8%, and then sieved with a 40-mesh sieve and subjected to granulation; the granulation included the process that the sieved ball-milled material and a binder were mixed uniformly and then sieved with a 30-mesh sieve under a pressure of 300 kg/cm² to obtain granulated particles; the binder was a polypropylene glycol solution with a concentration of 5 wt %, and the polypropylene glycol solution was 8% by mass of the dried ball-milled material in step (3); and
(5) the granulated particles in step (4) were molded and sintered sequentially to obtain the bi-component microwave ferrite material; the molding included the process that the granulated particles obtained in step (4) were compressed in a mold into a round blank, and the round blank had a molding density of 3.8 g/cm³; the sintering was performed at 1420° C. with a heating rate of 0.8° C./min, the sintering had a holding period of 11 h, and oxygen was introduced to the sintering 6 hours before the holding period ended, and after the holding period ended, oxygen was stopped to be introduced when temperature was reduced to 900° C.

The obtained sample was ground and then tested for the magnetic properties as shown in Table 1.

### Comparative Example 5

Based on the ionic substitution mechanism, this comparative example provides a microwave ferrite material, and the microwave ferrite material is:
Y_{2.6}Ca_{0.4}Fe_{4.2}Al_{0.4}Zr_{0.4}O₁₂.

A preparation method for the microwave ferrite comprises the following steps:
(1) raw materials were weighed out according to the calculation based on the formulation; the raw materials weighed out were put into a ball mill jar and mixed with zirconium balls, deionized water and ammonium citrate according to a mass ratio of 1:7:1.3:0.09, and subjected to wet ball milling for 8 h with a rotational speed of 40 r/min; a mass ratio of large-diameter zirconium balls to small-diameter zirconium balls was 5:2; the large-diameter zirconium balls had a diameter of 10 mm, and the small-diameter zirconium balls had a diameter of 4 mm; a particle size range of the obtained ball-milled material was D50=1.2 μm and D90=2.5 μm;
(2) the ball-milled material obtained in step (1) was sequentially dried, sieved with a 40-mesh sieve and pre-sintered; the drying was performed at 120° C. and stopped when a moisture content was reduced to 0.5%; the pre-sintering was performed at 1250° C. with a heating rate of 1° C./min, and the pre-sintering had a holding period of 8 h;
(3) the pre-sintered ball-milled material obtained in step (2) was crushed to obtain a powder, and the powder was sieved with a 30-mesh sieve and then mixed with zirconium balls and deionized water according to a mass ratio of 1:6:1.4 and subjected to wet ball milling for 20 h with a rotational speed of 60 r/min; a mass ratio of large-diameter zirconium balls to small-diameter zirconium balls was 1:1; the large-diameter zirconium balls had a diameter of 6 mm, and the small-diameter zirconium balls had a diameter of 2 mm; a particle size range of the obtained ball-milled material was D50=0.5 μm and D90=4 μm;
(4) the ball-milled material obtained in step (3) was dried at 250° C. until a moisture content was reduced to 8%, and then sieved with a 40-mesh sieve and subjected to granulation; the granulation included the process that the sieved ball-milled material and a binder were mixed uniformly and then sieved with a 30-mesh sieve under a pressure of 350 kg/cm² to obtain granulated particles; the binder was a polypropylene glycol solution with a concentration of 5 wt %, and the polypropylene glycol solution was 8% by mass of the dried ball-milled material in step (3); and
(5) the granulated particles in step (4) were molded and sintered sequentially to obtain the bi-component microwave ferrite material; the molding included the process that the granulated particles obtained in step (4) were compressed in a mold into a round blank, and the round blank had a molding density of 3.8 g/cm³; the sintering was performed at 1470° C. with a heating rate of 4° C./min, the sintering had a holding period of 12 h, and oxygen was introduced to the sintering 6 hours before the holding period ended, and after the holding period ended, oxygen was stopped to be introduced when temperature was reduced to 1000° C.

The obtained sample was ground and then tested for the magnetic properties as shown in Table 1.

### Comparative Example 6

Based on the ionic substitution mechanism, this comparative example provides a microwave ferrite material, and the microwave ferrite material is:
Y_{2.3}Ca_{0.7}Fe_{4.1}Sn_{0.4}Zr_{0.3}Mn_{0.2}Ti_{0.05}O₁₂.

A preparation method for the microwave ferrite comprises the following steps:
(1) raw materials were weighed out according to the calculation based on the formulation; the raw materials weighed out were put into a ball mill jar and mixed with zirconium balls, deionized water and ammonium citrate according to a mass ratio of 1:7.5:2:0.1, and subjected to wet ball milling for 40 h with a rotational speed of 80 r/min; a mass ratio of large-diameter zirconium balls to small-diameter zirconium balls was 3.5:4; the large-diameter zirconium balls had a diameter of 7 mm, and the small-diameter zirconium balls had a diameter of 1 mm; a particle size range of the obtained ball-milled material was D50=0.3 μm and D90=2 μm;
(2) the ball-milled material obtained in step (1) was sequentially dried, sieved with a 30-mesh sieve and pre-sintered; the drying was performed at 100° C. and stopped when a moisture content was reduced to 0.5%; the pre-sintering was performed at 1320° C. with a heating rate of 3.6° C./min, and the pre-sintering had a holding period of 15 h;
(3) the pre-sintered ball-milled material obtained in step (2) was crushed to obtain a powder, and the powder was sieved with a 30-mesh sieve and then mixed with zirconium balls and deionized water according to a mass ratio of 1:5.5:1.2 and subjected to wet ball milling for 10 h with a rotational speed of 10 r/min; a mass ratio of large-diameter zirconium balls to small-diameter zirconium balls was 3.5:4; the large-diameter zirconium balls had a diameter of 5 mm, and the small-diameter zirconium balls had a diameter of 3 mm; a particle size range of the obtained ball-milled material was D50=1 μm and D90=3 μm;
(4) the ball-milled material obtained in step (3) was dried at 250° C. until a moisture content was reduced to 8%, and then sieved with a 40-mesh sieve and subjected to granulation; the granulation included the process that the sieved ball-milled material and a binder were mixed uniformly and then sieved with a 30-mesh sieve under a pressure of 350 kg/cm² to obtain granulated particles; the binder was a polypropylene glycol solution with a concentration of 5 wt %, and the polypropylene glycol solution was 8% by mass of the dried ball-milled material in step (3); and
(5) the granulated particles in step (4) were molded and sintered sequentially to obtain the bi-component microwave ferrite material; the molding included the process that the granulated particles obtained in step (4) were compressed in a mold into a round blank, and the round blank had a molding density of 3.8 g/cm³; the sintering was performed at 1400° C. with a heating rate of 3.3° C./min, the sintering had a holding period of 5=15 h, and oxygen was introduced to the sintering 6 hours before the holding period ended, and after the holding period ended, oxygen was stopped to be introduced when temperature was reduced to 1000° C.

The obtained sample was ground and then tested for the magnetic properties as shown in Table 1.

### Comparative Example 7

This comparative example provides a bi-component microwave ferrite material, and the bi-component microwave ferrite material comprises a first microwave ferrite material and a second microwave ferrite material.

The first microwave ferrite material is: Y_{1.5}Ca_{1.2}Fe_{3.9}V_{0.6}Zr_{0.3}In_{0.3}Mn_{0.1}O₁₂; and the second microwave ferrite material is: Gd_{1.5}Ca_{0.85}Fe_{3.2}V_{0.35}Ge_{0.3}In_{0.3}Ti_{0.1}O₁₂.

A preparation method for the bi-component microwave ferrite material provided in this comparative example is the same as that of Example 1.

The obtained sample was ground and then tested for the magnetic properties as shown in Table 1.

### Comparative Example 8

This comparative example provides a bi-component microwave ferrite material, and the bi-component microwave ferrite material comprises a first microwave ferrite material and a second microwave ferrite material.

The first microwave ferrite material is: Y_{1.5}Ca_{1.2}Fe_{3.9} Al_{0.6}Zr_{0.3} In_{0.3}Mn_{0.1}O₁₂; and the second microwave ferrite material is: Gd_{1.5}Ca_{0.85}Fe_{3.2}Al_{0.35}Ge_{0.3}In_{0.3}Ti_{0.1}O₁₂.

A preparation method for the bi-component microwave ferrite material provided in this comparative example is the same as that of Example 1.

The obtained sample was ground and then tested for the magnetic properties as shown in Table 1.

### Comparative Example 9

This comparative example provides a bi-component microwave ferrite material, and the bi-component microwave ferrite material comprises a first microwave ferrite material and a second microwave ferrite material;
the first microwave ferrite material is: Y_{(3-2a-c-d-e)}Ca_{(2a+c+d+e)}Fe_{(5-a-b-c-d-e)}VₐAl_{b}Zr_{c}Sn_{d}MnₑO₁₂, wherein a=0.35, b=0.15, c=0.2, d=0.1, and e=0.04; and

the second microwave ferrite material is: Gd_{(3-2A-C-D)}Ca_{(2A+C+D)}Fe_{(5-A-B-C-D-E)}V_{A}Al_{B}Ge_{C}In_{D}Ti_{E}O₁₂, wherein A=0.35, B=0.05, C=0.1, D=0.1, and E=0.05.

A preparation method for the bi-component microwave ferrite material provided in this comparative example is the same as that of Example 1.

The obtained sample was ground and then tested for the magnetic properties as shown in Table 1.

The magnetic properties of the microwave ferrite materials provided in Examples 1-10 and Comparative Examples 1-9 are shown in Table 1.

TABLE 1

| | | Ferromagnetic | | | |
|---|---|---|---|---|---|
| | Saturation | resonance | | Dielectric | Curie |
| | magnetization | linewidth | Density | loss tgδₑ | temperature |
| | 4πMs (Gs) | ΔH (Oe) | ρ | (×10⁻⁴) | Tc (° C.) |
| Example 1 | 1952 | 14 | 4.9 | 1.48 | 262 |
| Example 2 | 1953 | 11 | 5.0 | 1.96 | 268 |
| Example 3 | 1958 | 17 | 5.2 | 1.26 | 269 |
| Example 4 | 1957 | 15 | 5.1 | 1.49 | 257 |
| Example 5 | 1954 | 14 | 5.2 | 2 | 273 |
| Example 6 | 1951 | 12 | 5.0 | 1.72 | 262 |
| Example 7 | 1956 | 18 | 5.5 | 1.83 | 269 |
| Example 8 | 1950 | 16 | 4.9 | 2 | 260 |
| Example 9 | 1954 | 19 | 5.3 | 2.13 | 272 |
| Example 10 | 1952 | 20 | 5.1 | 2.06 | 269 |
| Comparative | 1821 | 22 | 4.5 | 2.53 | 253 |
| Example 1 | | | | | |
| Comparative | 1798 | 20 | 4.2 | 2.62 | 249 |
| Example 2 | | | | | |
| Comparative | 1200 | 25 | 4.6 | 3 | 235 |
| Example 3 | | | | | |
| Comparative | 1650 | 35 | 4.5 | 2.5 | 180 |
| Example 4 | | | | | |
| Comparative | 1100 | 45 | 4.6 | 4 | 220 |
| Example 5 | | | | | |
| Comparative | 2000 | 68 | 4.8 | 5.6 | 195 |
| Example 6 | | | | | |
| Comparative | 1389 | 21 | 4.2 | 2.06 | 254 |
| Example 7 | | | | | |
| Comparative | 1420 | 19 | 4.6 | 2.12 | 249 |
| Example 8 | | | | | |
| Comparative | 1250 | 15 | 5 | 1.58 | 265 |
| Example 9 | | | | | |

As can be seen from Table 1, the high-saturation low-loss bi-component microwave ferrite material provided by the present application is characterized by the high saturation magnetic moment, high Curie temperature, low linewidth, and low loss; based on the analysis of Comparative Examples 1-9, it can be found that the single-component microwave ferrite material has a wider ferrimagnetic resonance linewidth, higher dielectric loss, and lower Curie temperature, and which thereby will greatly affect the stability and reliability of the single-component microwave ferrite material and in turn affect the use of microwave communication devices. Based on the analysis of Comparative Examples 7-9 and Example 1, it can be seen that the bi-component microwave ferrite materials having different chemical element compositions have different magnetic properties, which enables the two materials to have different application fields in microwave communication, and the ferrite material provided in Example 1 has a higher saturation magnetic moment, which is suitable for high-field operation of the circulator, and the ferrite material provided in Comparative Example 7 has a lower saturation magnetic moment, which is suitable for low-field operation of the circulator.

In summary, the high-saturation low-loss bi-component microwave ferrite material provided by the present application is characterized by the high saturation magnetic moment, high Curie temperature, low linewidth, and low loss; the saturation magnetization is 1950 Gs-1960 Gs, the dielectric loss is 2×10⁻⁴-1.48×10⁻⁴, the Curie temperature can reach 260° C. or more, and the linewidth is less than 20 Oe; moreover, the preparation method in the present application is stable and repeatable, which is conducive to industrialized production.

The above specific examples provide a further detailed description of the purposes, technical solutions and beneficial effects of the present application, and it should be understood the above contents are only the specific examples of the present application and are not intended to limit the present application.

What is claimed is:

1. A high-saturation low-loss bi-component microwave ferrite material, wherein raw materials for the high-saturation low-loss bi-component microwave ferrite material comprises a first microwave ferrite material and a second microwave ferrite material;
the first microwave ferrite material is: Y₃₋ₐCaₐFe_{5-a-b-c}ZrₐIn_{b}Mn_{c}O₁₂, wherein 0≤a≤0.7, 0≤b≤0.7, and 0≤c≤0.7; and
the second microwave ferrite material is: Gd_{3-A}Ca_{A}Fe_{5-A-B-C}Ge_{A}In_{B}Ti_{C}O₁₂, wherein 0≤A 0.7, 0≤B≤0.7, and 0≤C≤0.7.

2. The high-saturation low-loss bi-component microwave ferrite material according to claim 1, wherein a mass ratio of the first microwave ferrite material to the second microwave ferrite material is (1-3):(1-3).

3. A preparation method for the bi-component microwave ferrite material according to claim 1, wherein the preparation method comprises the following steps:
(1) mixing the first microwave ferrite material and the second microwave ferrite material according to a formulation proportion, and then performing wet ball milling to obtain a ball-milled material;
(2) drying the ball-milled material obtained in step (1), sieving and performing granulation; and
(3) molding and sintering particles after granulation in step (2) sequentially to obtain the high-saturation low-loss bi-component microwave ferrite material.

4. The preparation method according to claim 3, wherein the wet ball milling in step (1) is performed with mixing the raw materials, mill balls and a dispersion medium according to a mass ratio of 1:(4-7.5):(0.6-2.5);
optionally, the wet ball milling in step (1) is performed at a rotational speed of 20-80 r/min;
optionally, the wet ball milling in step (1) is performed for 10-40 h;
optionally, the mill balls comprise zirconium balls and/or steel balls;
optionally, the mill balls comprise large-diameter mill balls and small-diameter mill balls; the large-diameter mill balls have a diameter of 5-10 mm; the small-diameter mill balls have a diameter of 1-4 mm;
optionally, a mass ratio of the large-diameter mill balls to the small-diameter mill balls is (0.8-3):1;
optionally, the dispersion medium comprises any one or a combination of at least two of deionized water, alcohol, acetone, n-acetone or ammonia;
optionally, a particle size range of the ball-milled material in step (1) is: D50=0.05-2 μm and D90=0.05-4 μm.

5. The preparation method according to claim 3, wherein the drying in step (2) is performed at 100-150° C.;
optionally, the drying in step (2) is stopped when a moisture content is reduced to 0.01-10%;
optionally, the sieving in step (2) is performed with a sieve of 30-100 mesh;
optionally, the granulation in step (2) comprises uniformly mixing a sieved ball-milled material and a binder and sieving under pressure to obtain granulated particles;
optionally, the binder comprises an aqueous solution of polyvinyl alcohol;
optionally, the aqueous solution of polyvinyl alcohol has a concentration of 5-20 wt %;
optionally, the aqueous solution of polyvinyl alcohol is 5-10% by mass of the sieved ball-milled material;
optionally, the sieving is performed at a pressure of 300-1200 kg/m².

6. The preparation method according to claim 3, wherein the molding in step (3) comprises introducing the granulated particles in step (2) into a mold and compressing into a blank having a prescribed shape;
optionally, the blank has a molding density of 3.0-4.0 g/cm³;
optionally, the sintering in step (3) comprises heating to 1200-1500° C. at a heating rate of 1-5° C./min and holding for 5-30 h;
optionally, oxygen is introduced to the sintering in step (3) 1-6 hours before a holding period ends;
optionally, oxygen is stopped to be introduced to the sintering in step (3) when temperature is reduced by 100-500° C. after the holding period ends.

7. The preparation method according to claim 3, wherein a preparation method for the first microwave ferrite material in step (1) comprises the following steps:
(a) mixing raw materials for the first microwave ferrite according to a formulation proportion, and performing wet ball milling to obtain a ball-milled material; and
(b) drying, sieving and pre-sintering the ball-milled material obtained in step (a) sequentially to obtain the first microwave ferrite material;
the first microwave ferrite material is: Y₃₋ₐCaₐFe_{5-a-b-c}ZrₐIn_{b}Mn_{c}O₁₂, wherein 0≤a≤0.7, 0≤b≤0.7, and 0≤c≤0.7;
optionally, the wet ball milling in step (a) comprises performing the wet ball milling with mixing the raw materials, mill balls, a dispersion medium and a dispersant according to a mass ratio of 1:(4-7.5):(0.6-2.5):(0.003-0.01);
optionally, the wet ball milling in step (a) is performed at a rotational speed of 20-80 r/min;
optionally, the wet ball milling in step (a) is performed for 10-40 h;
optionally, the mill balls for the wet ball milling in step (a) comprise zirconium balls and/or steel balls;
optionally, the mill balls for the wet ball milling in step (a) comprise large-diameter mill balls and small-diameter mill balls; the large-diameter mill balls have a diameter of 5-10 mm; the small-diameter mill balls have a diameter of 1-4 mm;
optionally, in the mill balls for the wet ball milling in step (a), a mass ratio of the large-diameter mill balls to the small-diameter mill balls is (0.8-3):1;
optionally, the dispersion medium for the wet ball milling in step (a) comprises any one or a combination of at least two of deionized water, alcohol, acetone, n-acetone or ammonia;
optionally, the dispersant for the wet ball milling in step (a) comprises ammonium citrate and/or ammonia;
optionally, a particle size range of the ball-milled material in step (a) is: D50=0.05-2 μm and D90=0.05-4 μm;
optionally, the drying in step (b) is performed at 100-150° C.;
optionally, the drying in step (b) is stopped when a moisture content is reduced to 0.01-10%;
optionally, the sieving in step (b) is performed with a sieve of 30-100 mesh;
optionally, the pre-sintering in step (b) is performed at 1100-1400° C.;
optionally, the pre-sintering in step (b) is performed with a holding period of 6-15 h;
optionally, the pre-sintering in step (b) is performed at a heating rate of 0.3-4° C./min.

8. The preparation method according to claim 3, wherein a preparation method for the second microwave ferrite material in step (1) comprises the following steps:
(I) mixing raw materials for the second microwave ferrite according to a formulation proportion, and performing wet ball milling to obtain a ball-milled material; and
(II) drying, sieving and pre-sintering the ball-milled material obtained in step (I) sequentially to obtain the second microwave ferrite material;
the second microwave ferrite material is: Gd_{3-A}Ca_{A}Fe_{5-A-B-C}Ge_{A}In_{B}Ti_{C}O₁₂, wherein 0≤A 0.7, 0≤B≤0.7, and 0≤C≤0.7;
optionally, the wet ball milling in step (I) comprises performing the wet ball milling with mixing the raw materials, mill balls, a dispersion medium and a dispersant according to a mass ratio of 1:(4-7.5):(0.6-2.5):(0.003-0.01);
optionally, the mill balls for the wet ball milling in step (I) comprise zirconium balls and/or steel balls;
optionally, the mill balls for the wet ball milling in step (I) comprise large-diameter mill balls and small-diameter mill balls; the large-diameter mill balls have a diameter of 5-10 mm; the small-diameter mill balls have a diameter of 1-4 mm;
optionally, in the mill balls for the wet ball milling in step (I), a mass ratio of the large-diameter mill balls to the small-diameter mill balls is (0.8-3):1;
optionally, the dispersion medium in step (I) comprises any one or a combination of at least two of deionized water, alcohol, acetone, n-propanol or ammonia;
optionally, the dispersant in step (I) comprises ammonium citrate and/or ammonia;
optionally, the wet ball milling in step (I) is performed at a rotational speed of 20-80 r/min;
optionally, the wet ball milling in step (I) is performed for 10-40 h;
optionally, a particle size range of the ball-milled material in step (I) is D50=0.0050.05-2 μm and D90=0.05-4 km;
optionally, the drying in step (II) is performed at 100-150° C.;
optionally, the drying in step (II) is stopped when a moisture content is reduced to 0.01-10%;
optionally, the sieving in step (II) is performed with a sieve of 30-100 mesh;
optionally, the pre-sintering in step (II) is performed at 1100-1400° C.;
optionally, the pre-sintering in step (II) is performed with a holding period of 8-20 h;
optionally, the pre-sintering in step (II) is performed at a heating rate of 0.3-4° C./min.

9. The preparation method according to claim 3, which comprises the following steps:
(1) mixing the first microwave ferrite material and the second microwave ferrite material according to a formulation proportion, and then performing wet ball milling to obtain a ball-milled material; the wet ball milling is performed with a rotational speed of 20-80 r/min for 10-40 h by mixing the raw materials, mill balls and a dispersion medium according to a mass ratio of 1:(4-7.5):(0.6-2.5); a particle size range of the ball-milled material is: D50=0.05-2 μm and D90=0.05-4 μm;
(2) drying the ball-milled material obtained in step (1) at 100-250° C. until a moisture content is reduced to 0.01-10%, sieving with a sieve of 30-100 mesh and performing granulation; wherein the granulation comprises uniformly mixing a sieved ball-milled material and a binder and sieving with a sieve of 30-100 mesh at a pressure of 300-1200 kg/cm² to obtain granulated particles; and
(3) molding and sintering the granulated particles in step (2) sequentially to obtain the high-saturation low-loss bi-component microwave ferrite material; the molding comprises compressing the granulated particles obtained in step (2) in a mold into a blank having a prescribed shape, and the blank has a molding density of 3.0-4.0 g/cm³; the sintering is performed at 1200-1500° C. with a heating rate of 1-5° C./min, the sintering has a holding period of 5-30 h, and oxygen is introduced to the sintering 1-6 hours before the holding period ends, and after the holding period ends, oxygen is stopped to be introduced when temperature is reduced by 100-500° C.;
a preparation method for the first microwave ferrite material in step (1) comprises:
(a) mixing raw materials for the first microwave ferrite according to a formulation proportion and performing wet ball milling to obtain a ball-milled material; the wet ball milling is performed with a rotational speed of 20-80 r/min for 10-40 h; a particle size range of the obtained ball-milled material is: D50=0.05-2 μm, and D90=0.05-4 μm; and
(b) drying, sieving, with a sieve of 30-100 mesh, and pre-sintering the ball-milled material obtained in step (a) sequentially to obtain the first microwave ferrite material; the drying is performed at 100-250° C. and stopped when a moisture content is reduced to 0.01-10%; the pre-sintering is performed at 1100-1350° C.; the pre-sintering has a holding period of 6-15 h; the pre-sintering is performed at a heating rate of 0.3-4° C./min;
a preparation method for the second microwave ferrite material in step (1) comprises:
(I) mixing raw materials for the second microwave ferrite according to a formulation proportion, and performing wet ball milling to obtain a ball-milled material; the wet ball milling is performed with a rotational speed of 20-80 r/min for 10-40 h; a particle size range of the obtained ball-milled material is: D50=0.05-2 μm, and D90=0.05-4 μm; and
(II) drying, sieving and pre-sintering the ball-milled material obtained in step (I) sequentially to obtain the second microwave ferrite material; the drying is performed at 100-250° C. and stopped when a moisture content is reduced to 0.01-10%; the pre-sintering is performed at 1100-1400° C.;
the pre-sintering is performed with a holding period of 8-20 h.

10. Use of the high-saturation low-loss bi-component microwave ferrite material according to claim 1, wherein the high-saturation low-loss bi-component microwave ferrite material is used for a microwave communication device.
